(19) United States
(12) Patent Application Publication
(10) Pub. No.: US 2012/0219774 A1
(43) Pub. Date: Aug. 30, 2012

(54) TRANSPARENT FILM

(76) Inventor: Hirotsugu Kishimoto, Osaka (JP)

(21) Appl. No.: 13/504,668

(22) PCT Filed: Oct. 25, 2010
(86) PCT No.: PCT/JP2010/069247

§ 371 Date: Apr. 27, 2012

(30) Foreign Application Priority Data
Oct. 27, 2009 (JP) 2009-247119

(51) Int. Cl. B32B 17/10; B32B 27/40; B32B 27/38

(52) U.S. Cl. 428/212

(57) ABSTRACT

The present invention is intended to provide a transparent film with superior transparency and a heat-resistant, reduced retardation, for being suitable for application of liquid-crystal displays. This transparent film comprises a glass fiber substrate and a transparent resin impregnated to the substrate. This transparent film satisfies a relation of 0.001≦n2−n1≦0.007 in terms of a refractive index difference n2−n1 between the glass fiber (refractive index n1) and the transparent resin (refractive index n2). This transparent resin has a peak wavelength in a range of 600 nm to 780 nm in terms of the maximum light transmission.

### TECHNICAL FIELD

The present invention relates to transparent films for use as substrates of liquid crystal display and the like.

### TECHNICAL FIELD

Many researches have been carried out to develop thin-light flat panel displays, such as liquid crystal display, plasma display and EL display. Plastic film has attracted attention as an alternative to a glass substrate for further development of the panel display. The plastic film can serve as an alternative to glass substrate, so as to provide a thin and light flat panel display with a reduced fragility and a superior flexibility.

Japanese unexamined patent application publications No. 2004-307851 and No. 2009-066931 respectively disclose transparent films. Each transparent film is formed of a transparent resin and a glass fiber substrate. Each transparent film exhibits a high thermal resistance and a high dimensional stability under temperature and humidity changes as well as general properties of transparent plastic films.

This transparent film is prepared from a resin composition. The resin composition can be fabricated by mixing a high refractive resin having a larger refractive index than a glass fiber, with a low refractive resin having a lower refractive index than the glass fiber, so as to have a refractive index approximate to that of the glass fiber. Next, the glass fiber substrate is impregnated with the resin composition, and then dried to a semi-cured state in order to from a prepreg. The prepreg are heat-pressed to form the transparent film. Each of the high refractive resin and the low refractive resin is formed of an epoxy resin.

The glass fiber substrate can be combined with the matrix resin (resin composition) to provide a transparent film, which is suitable for application to the display with a reduced refraction within the transparent film as well as a superior visibility.

This transparent film has been attracted as a material capable of having a high adhesion to electrical conductive films such as ITO film, a high surface smoothness and a high gas barrier performance, as well as general properties such as high transparency, high thermal resistance and high dimensional stability required for application to liquid crystal displays or the like.

However, the transparent film made of transparent resin and the glass fiber substrate needs to be improved in terms of a retardation. When utilized as an alternative to a glass substrate for production of liquid crystal displays, this transparent film causes the retardation due to a phase difference between transmitting lights resulting from birefringence, leading to degradation in display quality.

### DISCLOSURE OF THE INVENTION

The present invention has been accomplished in view of the above problems, and has an object to provide a transparent film with high transparency, a high thermal resistance and a reduced retardation which serves as a suitable material for production of a liquid crystal display or the like.

The transparent film in the present invention comprises a transparent material made of a transparent resin, and a glass fiber substrate made of glass fiber. The glass fiber substrate is impregnated with the transparent material. The transparent film satisfies a relation of 0.001≦n2−n≦0.007 in which n1 and n2 are respectively refractive indexes of the glass fiber and the transparent material. The transparent film gives a maximum light transmission at a wavelength of 600 nm to 780 nm. This invention enables to provide a transparent film with a high transparency and a minimized retardation.

In the above transparent film, the transparent material preferably comprises a plurality of transparent resins having different refractive indexes.

In the transparent film, the above transparent material preferably comprises a high refractive resin and a low refractive resin. The high refractive resin has a refractive index higher than the refractive index n1 of the glass fiber. The low refractive resin has a refractive index lower than the refractive index n1 of the glass fiber.

In the above transparent film, the high refractive resin is preferably formed of either one or both of a cyanate ester resin, a multi-functional epoxy resin expressed by the following formula (I);

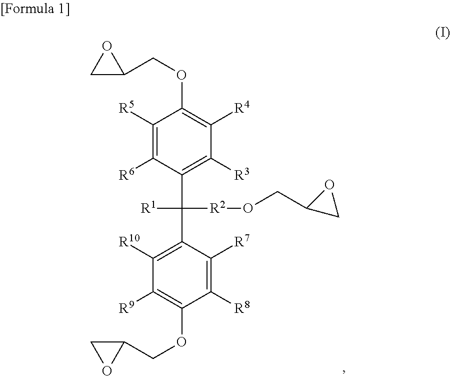

wherein R¹ is hydrogen atom or methyl group, R² is a divalent organic group, and each of R³ to R¹⁰ is one selected from a group consisting of a hydrogen atom, a substituent group, and a molecular chain containing epoxy group.

In the above transparent film, the low refractive resin is preferably formed of a multi-functional epoxy resin expressed by the following formula (II),

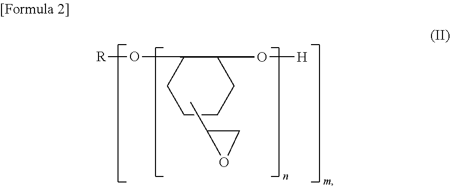

wherein m and n are positive integers, and R is an m-valent organic group.

In the above transparent film, the glass fiber is preferably an E-glass fiber or a T-glass fiber.

In the above transparent film, the high refractive resin is preferably formed of a cyanate ester resin and a multi-functional epoxy resin expressed by the following formula (I);

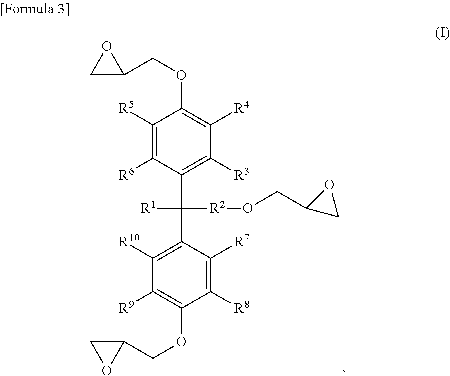

wherein R¹ is hydrogen atom or methyl group, R² is a divalent organic group, and each of R³ to R¹⁰ is one selected from a group consisting of a hydrogen atom, a substituent group, and a molecular chain containing epoxy group. In addition, the low refractive resin is preferably formed of a multi-functional epoxy resin expressed by the following formula (II),

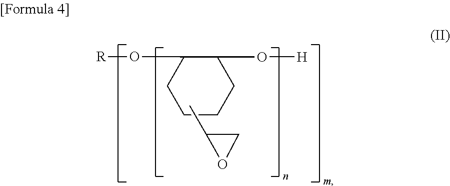

wherein m and n are positive integers, and R is an m-valent organic group. In this transparent film, the glass fiber is preferably an E-glass fiber. More preferably, this transparent film comprises 38% to 43% by weight of the low refractive resin, with respect to a total content of the high refractive resin and the low refractive resin.

In the above transparent film, the high refractive resin is preferably formed of a multi-functional epoxy resin expressed by the following formula (I);

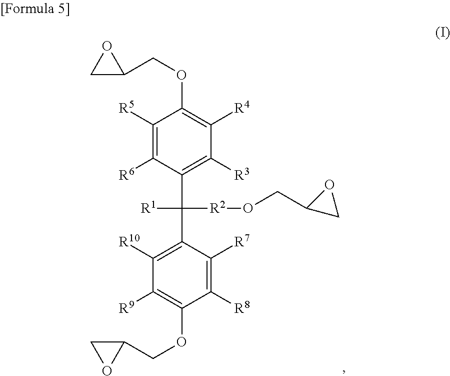

wherein R¹ is hydrogen atom or methyl group, R² is a divalent organic group, and each of R³ to R¹⁰ is one selected from a group consisting of a hydrogen atom, a substituent group, and a molecular chain containing epoxy group. In addition, the low refractive resin is preferably formed of a multi-functional epoxy resin expressed by the following formula (II),

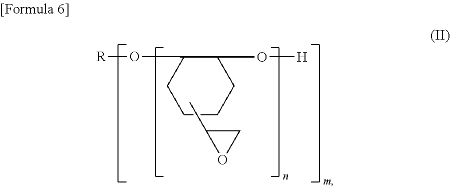

wherein m and n are positive integers, and R is an m-valent organic group. In this transparent film, the glass fiber is preferably a T-glass fiber. More preferably, this transparent film comprises 90% to 96% by weight of said low refractive resin, with respect to a total content of said high refractive resin and said low refractive resin.

In the above transparent film, a hard coat layer is preferably provided on at least one of opposite surfaces thereof.

In the above transparent film, a gas barrier layer is preferably provided on at least one of opposite surfaces thereof.

### DETAILED DESCRIPTION OF THE INVENTION

The present invention is described in detail below.

The transparent film in the present invention comprises a glass fiber substrate and a transparent material. The glass fiber substrate is made of glass fiber, and impregnated with the transparent material. The transparent material is made of a high refractive resin having a higher refractive index than said glass fiber, and a low refractive resin having a lower refractive index than said glass fiber, so as to have a refractive index approximate to that of the glass fiber. This transparent material is impregnated to the glass fiber substrate, and then cured to form the transparent film in the present invention.

This high refractive index is preferably formed of either one or both of a cyanate ester resin and a multi-functional epoxy resin having the following formula (I).

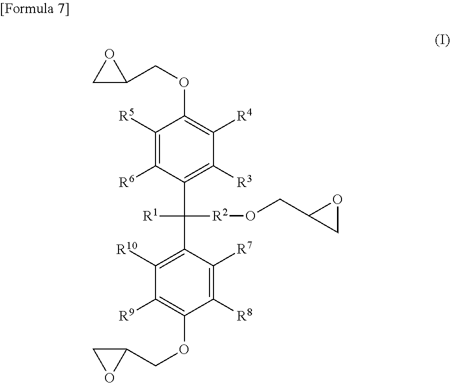

The cyanate ester resin is made of at least one of 2,2-bis(4-cyanatephenyl)propane, bis(3,5-dimethyl-4-cyanatephenyl)methane, 2,2-bis(4-cyanatephenyl)ethane, derivatives of these compounds, aromatic cyanate ester compound, and so on.

The cyanate ester resin is cured together with an epoxy resin to have a rigid structure including triazine rings and oxazorin rings, improving cross-linking density of the epoxy resin. It enables to provide the transparent film with a high glass transition temperature. When being utilized as the high refractive resin, the cyanate ester resin enables to provide a transparent film with a high transparency, a reduced retardation, a high glass transition temperature and a high thermal resistance. Since the cyanate ester resin is solid at ambient temperature, the transparent material can be easily dried by touch drying to form a prepreg after impregnated to the glass fiber substrate, allowing the prepreg to be easily handled.

The transparent material contains preferably 10% to 40%, more preferably 25% to 35% by weight of a cyanate ester resin, with respect to sum of the high refractive resin content and the low refractive resin content. When the transparent material contains the cyanate ester resin too low, the glass transition temperature may not be sufficiently improved in the resultant transparent film. When the resin composition contains the cyanate ester resin too much, the cyanate ester resin may not be fully dissolved, and crystallized from a varnish during production of the transparent resin and preservation of the transparent resin.

The multi-functional epoxy resin the above formula (I) can be employed to provide a transparent film with an improved glass transition temperature and high thermal resistance as well as a high improved high transparency. The transparent film is free from thermally-induced coloring. When utilized as the high refractive resin, the multi-functional epoxy resin having the above formula (I) enables to provide this transparent film with a high transparency and a reduced retardation, a high glass transition temperature, a high thermal resistance and a reduced heat-induced coloring, at a low cost.

The divalent organic substituent R² in formula (I) may be phenylene-substituted arylene, unsubstituted arylene, a structure containing substituted or unsubstituted arylene and organic moieties, or the like. The organic moiety may be alkylene group (e.g., methylmethylnene group and dimethylmethylnene group), carbonyl group, or the like.

The divalent organic substituent R² in formula (I) preferably contains a phenylene group which is bound to a glycidyloxy group in the right side of formula (I). Preferably, the divalent organic substituent R² does not contain a methylene group interposed between arylene groups, for forming the transparent film free from thermally-induced coloring.

The divalent organic substituent R² may be one of moieties in rectangular parentheses in the following structures, or the like.

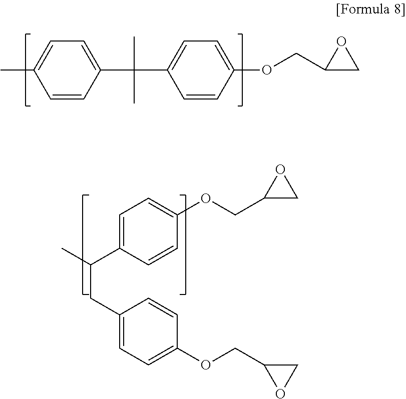

Substituents R³ to R¹⁰ in formula (I) are not limited to particular moieties, and may be hydrocarbon groups such as lower alkyl groups, or other organic moieties. The substituents R³ to R¹⁰ may be a moiety in rectangular parentheses in the following structure wherein a symbol “p” represents a positive integer.

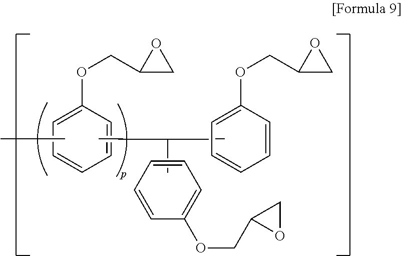

The multi-functional epoxy resin may be one of multi-functional epoxy resins represented by the following formulas (1-a), (1-b), (1-c) wherein a symbol “q” is a positive integer, or the like.

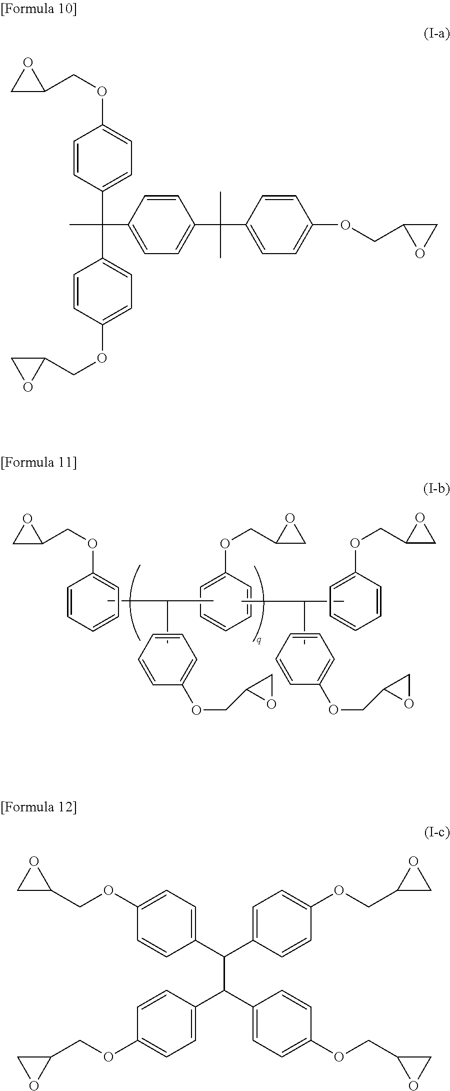

Each of the cyanate ester resin, the multifunctional epoxy resin having the formula (I) and the mixture thereof is selected as the high refractive resin. The selected high refractive resin preferably has a refractive index of 1.58 to 1.63. When an E-glass fiber having a refractive index of 1.563 is employed as the glass fiber, the high refractive resin preferably has a refractive index of ca. 1.6. When the E-glass fiber has a refractive index of n, the refractive index of the high refractive resin preferably ranges from n+0.03 to n+0.06. When a T-glass fiber having a refractive index of 1.528 is employed as the glass fiber, the high refractive resin preferably has a refractive index of ca. 1.6. When the T-glass fiber has a refractive index of n, the refractive index of the high refractive resin preferably ranges from n+0.03 to n+0.08.

The refractive index is determined for each resin in cured state (cured resin), in accordance with ASTM D 542.

In the present invention, an epoxy resin can be employed as the low refractive resin having a lower refractive index than the glass fiber. The epoxy resin is preferably a multi-functional epoxy resin having the following formula (II). The multi-functional epoxy resin is alicyclic and exhibits high transparency, serving to increase a glass transition temperature and enhance a high thermal resistance of the cured product. When utilized as the low refractive resin, the multi-functional epoxy resin having the following formula (II) enables to provide this transparent film with a high transparency and a reduced retardation, a high glass transition temperature and a high thermal resistance, at a low cost.

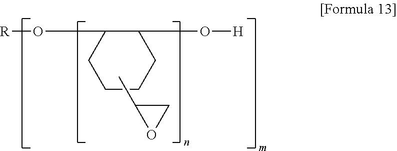

The organic substituent R having alicyclic epoxy structure in rectangular parentheses in the above formula (II) can be suitably selected not to lose advantageous effect of the present invention. The organic substituent R may be a linear alkyl (or branched alkyl) having one to ten carbon atoms. The symbol “m” in the formula (II) is not limited to a particular number, and may be one of 1 to 5 or other. The symbol “n” is not limited to a particular number, but preferably selected such that the resin is solid and loses its flowability in ambient temperature (25° C.) for facilitating production of the transparent film.

The multi-functional epoxy resin having the above formula (II) may be a product obtained by addition of 2,2-bis(hydroxymethyl)-1-butanol to 1,2-epoxy-4-(2-oxiranyl)cyclohexane. Specifically, the multi-functional epoxy resin may be one represented by the following formula (II-a) wherein repetitive numbers denoted by “n” are individually selected from positive integers.

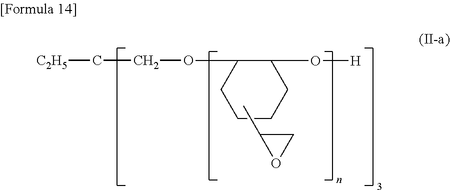

This multi-functional epoxy resin may have a melting point of ca. 85° C. Molecular weight of this multi-functional epoxy resin is not particularly limited, and may be in a range of 2000 to 3000 in terms of weight-average molecular weight.

A hydrogenated bisphenol epoxy resin may be employed as the low refractive resin, instead of the multi-functional epoxy resin having the above formula (II). The hydrogenated bisphenol epoxy resin may be a bisphenol A-type resin, a bisphenol F-type resin, a bisphenol S-type resin, or the like. The hydrogenated bisphenol epoxy resin is preferably solid at ambient temperature. The hydrogenated bisphenol epoxy resin may be liquid at ambient temperature, but may be incompletely dried to have some extent of viscosity, possibly making it difficult to handle the prepreg.

In the present invention, the low refractive resin preferably has a refractive index in a range of 1.47 to 1.53. When the grass fiber has a refractive index of 1.563 (E-glass fiber), the low refractive resin preferably has a refractive index of ca. 1.5. When the E-grass fiber has a refractive index of n, the low refractive resin preferably has a refractive index in a range of n−0.04 to n−0.08. When the T-glass fiber having a refractive index of 1.528 is employed as the glass fiber, the low refractive resin preferably has a refractive index of ca. 1.5. When the T-glass fiber has a refractive index of n, the refractive index of the high refractive resin preferably ranges from n−0.01 to n−0.03.

As described above, the transparent material in the present invention is prepared by mixing the high refractive resin with the low refractive resin to have a refractive index approximate to that of the glass fiber. In particular, the transparent film in the present invention satisfies a relation of 0.001≦n2−n1≦0.007 wherein n1 is a refractive index of the glass fiber and n2 is a refractive index of the transparent material. The mixing ratio of high refractive resin and the low refractive resin are suitably controlled to have a maximum light transmission at a wavelength of 600 nm to 780 nm. With the suitable mixing ratio, the transparent film enables to suppress a retardation while retaining its high transparency.

In the present invention, the transparent resin is controlled to have a refractive index n2 of the transparent material slightly larger than a refractive index n1 of the glass fiber, in view of the fact that the transparent material impregnated to the glass fiber receives tensional forces locally causing a refractive index reduction when cured. When controlled to have a slightly larger refractive index than the glass fiber, the transparent material enables to have a refractive index substantially coincident with that of the glass fiber after cured.

When a transparent material not impregnated to the glass fiber substrate is controlled to have a refractive index coincident with that of the glass fiber, the resultant transparent film gives a maximum light transmission at a wavelength of ca. 550 nm. When controlled to satisfy a relation of 0.001≦n2−n1≦0.007, the resultant transparent film gives a maximum light transmission at a wavelength of 600 nm or more.

E-glass fiber is cheap and has a stable supply quality, thereby can be suitably employed as the glass fiber in a preferred embodiment of the present invention. In the preferred embodiment, the high refractive resin is a mixture of cyanate ester resin and the multi-functional epoxy resin having the above formula (I). The low refractive resin in the preferred embodiment is made of the multi-functional epoxy resin having the above formula (II). In the preferred embodiment, the transparent material contains 38% to 43% by weight of the low refractive resin, with respect to a total content of the high refractive resin and the low refractive resin. This transparent material enables to provide a transparent film with a minimized retardation less than 1.5 nm (or less than 1.4 nm) and a further improved thermal resistance while maintaining its high transparency. Namely, in the preferred embodiment, this transparent film is allowed to have a high transparency, a reduced retardation, a high glass transition temperature (e.g., 240° C.) and a high thermal resistance.

The T-glass fiber has a superior optical property, and is employed as the glass fiber in another preferred embodiment. In another preferred embodiment, the high refractive resin is made of the multi-functional epoxy resin having the above formula (I). The low refractive resin in another preferred embodiment is made of the multi-functional epoxy resin having the above formula (II). In another preferred embodiment, the transparent material contains 90% to 96% by weight of the multi-functional epoxy resin having the above formula (II), with respect to a total content of the multi-functional epoxy resins respectively having the formula (I) and (II). In another preferred embodiment, this transparent film is allowed to have a reduced retardation (e.g., less than 1.2 nm, or less than 1.0 nm), a significantly improved thermal resistance and a superior optical performance, while maintaining its high transparency.

The transparent material is preferably prepared to have a glass transition temperature (Tg) of 200° C. or more, more preferably 210° C. or more, further preferably 230° C. or more. With the high glass transition temperature of cured resin, the transparent film is enabled to have an increased thermal resistance. The maximum of the glass transition temperature is not particularly limited, but is set to be ca, 350° C. for practical use.

The glass transition temperature in the present invention is determined in accordance with JIS C6481 TMA method.

The transparent material in the present invention may be mixed with a cure initiator (curing agent), such as organometallic salt. The organometallic salt can be a combination of an organic acid (e.g., octanic acid, steallic acid, acethylacetonate, naphthenic acid, and salicylic acid) with a metal (e.g., Zn, Cu, Fe). The organic acid may be either one of the above listed compounds or a mixture thereof. The metal may be either one of the above listed metals or a mixture thereof. Zinc octanate is preferably employed as the cure initiator made of the organometallic salt, as being effective in increasing a glass transition temperature of the cured resin. The transparent material preferably contains 0.01 to 0.1 PHR of the oraganometallic salt made of zinc octanate or the like.

Cationic cure initiator may be employed as the cure initiator, for improving the transparency of the cured resin. The cationic cure initiator may be aromatic sulfonate, aromatic iodonium salt, aromatic ammonium salt, aluminum chelate, trifluoride boron amine complex, and the like. The transparent material preferably contains 0.2 to 0.3 PHR of the cationic cure initiator.

The cure initiator may be one of curing catalysts such as triethylamine, tertiary amine (e.g., triethanol amine), 2-ethyl-4-imidazole, 4-methylimidazole, 2-ethyl-4-methylimidazole. The transparent material preferably contains 0.5 to 5.0 PHR of the curing catalyst.

The transparent material can be prepared from a mixture of the high refractive resin, the low refractive resin, and the optional cure initiator. The transparent material may be diluted with solvent to prepare a varnish if necessary. The solvent may be benzene, toluene, xylene, methylethylketone, methylisobuthylketone, acetone, methanol, ethanol, isopropylalcohol, 2-butanol, ethylacetate, buthylacetate, propyreneglycolmonomethylether, propyreneglycolmonomethyletheracetate, diacetonealcohol, N-N′-dimethylacetoamide, or the like.

The glass fiber substrate is preferably formed of E-glass or NE-glass for providing an impact resistant transparent film, since these glasses are cheap and have stable supply quality. E-glass fiber is referred to as non-alkali glass fiber, and conventionally used as a glass fiber suitable for resin reinforcement. NE-glass represents New-E glass fiber. When utilized as the glass fiber, the E-glass fiber enables to provide the transparent film with a high transparency and a reduced retardation. T-glass has mechanical and thermal performances superior to conventional E-glass, and can be employed as the glass fiber. When utilized as the glass fiber, the T-glass fiber enables to provide the transparent film with a significantly reduced retardation value and a superior optical performance.

The glass fiber is preferably surface-treated with silane coupling agent conventionally used as a glass fiber treatment agent in advance, for providing a highly impact resistant transparent film. The glass fiber has a refractive index in a range of 1.52 to 1.57 preferably, or 1.525 to 1.565 more preferably, for providing a transparent film with superior visibility. The glass fiber substrate may be formed of nonwoven or woven-glass fiber.

The glass fiber substrate is impregnated with the varnish prepared from the transparent material, and then heat-dried to form a prepreg. The heat-drying can be performed in various ways, but is preferably performed at a temperature of 100 to 160° C. for one to ten minutes.

Either the prepreg or a laminate of plural prepregs can be heat-pressed such that the transparent film is cured to form the transparent film. The heat-pressing can be performed in various conditions, but is preferably performed at a temperature of 150 to 200° C. under a pressure of 1 to 4 MPa for 10 to 120 minutes.

The above transparent film has a superior thermal resistance and contains a resin matrix which is formed by polymerization of the high refractive resin and the low refractive resin. The resin matrix exhibits a high glass transition temperature and high thermal resistance.

Each of the high refractive resin and the low refractive resin has a superior transparency, promising a high transparency of the resultant transparent film. The transparent film contains preferably 25% to 65%, more preferably 35% to 60% by weight of the glass fiber substrate, for having a high impact-resistance with the aid of reinforcement of glass fiber as well as sufficient transparency. When containing the glass fiber too much, the transparent film has a highly bumpy surface and a degraded transparency. When containing the glass fiber too low, the transparent film may have an excessive thermal expansion efficiency.

The glass fiber substrate may be formed of a laminate of plural thin glass fiber plates, for having a high transparency. For example, the glass fiber substrate may be formed of a laminate of plural thin glass fiber plates each having a thickness of 50 μm or less. The thickness of each thin glass fiber plate is not particularly limited, but is preferably 10 μm or more for practical use. The number of thin glass fiber plate is not particularly limited, but is preferably twenty or less for practical use. In fabrication of the transparent film from the plural thin glass fiber plates, each thin glass fiber plate can be impregnated with the transparent material before laminated to each other. Next, the transparent material is dried to form a prepreg, and then the prepreg is heat-pressed to form the transparent film. Instead, the transparent material can be impregnated to the laminate of plural thin glass fiber plates, and then dried to form a prepreg, before the prepreg is heat-pressed.

The transparent film in the present invention exhibits a high transparency and high thermal resistance as well as a minimized retardation. The white-light transmission efficiency of the transparent film can be controlled to be 88% or more. The transparent film can be provided at its surface with ITO for exhibiting electrical conductivity, thereby suitable for application to liquid-crystal display and the like.

The transparent film in the present invention exhibits a stable dimensional stability and a low thermal expansion coefficient (CTE) especially along its face-direction (X-Y direction). For example, the thermal expansion coefficient along its surface is controlled to be 30 ppm/° C. or less at a temperature of 50° C. to 150° C.

The transparent film has a smoothened surface, and can be controlled to have a surface roughness (Rz) of 1 μm or less.

The transparent film in the present invention can be provided with a hard coat layer at least one of its opposite surfaces. This transparent film with the hard coat layer enables to have a significantly improved surface smoothness and hardness. The hard coat layer may be a conventional hard coat layer such as a plastic film. For example, the transparent film described above can be provided with an epoxy resin layer having a thickness of several micrometers by means of laminate transfer process, so as to provide a hard coat layer having a smoothed surface. Specifically, the epoxy resin with a large molecular weight dissolved into a solvent is applied to PET film or the like serving as a carrier film. Next, the resultant film is laminated on the transparent film made of transparent resin and the glass fiber substrate by use of vacuum laminator. Subsequently, the epoxy resin is subjected to UV-irradiation or thermal treatment for cured, and then the carrier film is removed to provide a hard coat layer having a smoothed surface.

The transparent film in the present invention can be provided with a gas-barrier layer at least one of its opposite surfaces. This transparent film with the gas-barrier layer enables to have a significantly improved surface smoothness and the gas-barrier performance. For example, the transparent film formed of the transparent resin and the glass fiber substrate can be provided at its surface with an inorganic film made of SiO₂ or SiONₓ by spattering. Instead, the transparent film may be provided with the inorganic film and an organic resin film to form the gas-barrier layer having a smoothed surface.

### EXAMPLE

Hereafter, the present invention is described in detail below, with reference to Example. The present invention is not limited to the following Example.

Each of transparent resins in Examples and Comparative examples contains the following ingredients.

The following substances were employed as high refractive resins:
TECHMORE VG3101 (available from Printec Co., Ltd. a tri-functional epoxy resin having a structure represented by the above (1-a), refractive index is 1.59)
BADCy (available from Lonza Group Ltd. solid cyanate ester resin, 2-2-bis(4-cyanatephenyl)propane, refractive index is 1.59)

The following substance was employed as a low refractive resin:
EHPE3150 (available from Daicel chemical industries, Ltd., a product obtained by addition of 2,2-bis(hydroxymethyl)-1-butanol to 1,2-epoxy-4-(2-oxyranyl)cyclohexane, epoxy equivalent 185, molecular weight 2234, refractive index 1.51)

The following substances were employed as cure initiators:
zinc octanate
SI-150L (available from Sanshin Chemical Industry Co., Ltd, cationic cure initiating agent (SbF₆-containing sulfonate))

The high refractive resin and the low refractive resin were mixed with each other in accordance with Table 1 (parts by weight), then mixed with the cure initiator. Subsequently, 50 parts by weight of toluene as a solvent and 50 parts by weight of methylethylketone were added to the resultant mixture, and then stirred at 70° C. to form a varnish made of the resins.

In fabrication of the transparent films in Examples 1 to 4 and Comparative example 1 and 2, a glass cloth having a thickness of 25 μm (available from Asahi Kasei Microdevices Corporation; E-glass fiber; refractive index, 1.563) was impregnated with the above varnish made of the resins, and then heated up to 150° C. for five minutes, such that the resin were semi-cured by solvent evaporation to provide prepregs. In fabrication of the transparent films in Examples 5 to 7 and Comparative example 3 and 4, a glass cloth having a 25 μm thickness (available from Nitto Boseki Co., Ltd; serial number, 1037; T-glass fiber; refractive index, 1.528) was impregnated with the above varnish made of the resins, instead of the above glass cloth (E-glass fiber), to provide prepregs in the same way.

Two resultant prepregs were laminated on each other, disposed in a press apparatus, and then heat-pressed at 170° C. under 2 MPa for 15 minutes, so as to form a transparent film which contains 63% by weight of the resin and has a thickness of 70 μm.

The above transparent films in Examples and Comparative examples were evaluated through the following measurements.

### [Transparency]

Haze value was measured for the above transparent films by means of a haze meter NDH2000 (available from Nippon Denshoku industries Co., Ltd.) in accordance with JISK7136.

### [Glass Transition Temperature]

The prepreg was scratched to eliminate resin component, and then pressed in the same way as in fabrication of the transparent film to form a resin plate sample. Glass transition temperature was measured for the resin plate sample, in accordance with JIS C6481 TMA method.

### [Refractive Index of Cured Resin]

Refractive index was measured by means of a refractive index measurement apparatus (available from Atago Co., Ltd.) in accordance with ASTM D542, for a sample plate obtained by polishing the above resin plate sample.

### [Peak Wavelength of Light Transmission]

Transmission spectrum was obtained for the transparent films by means of a UV-visible spectrophotometer, for determination of a wavelength of the maximum light transmission (peak wavelength). [Retardation]
Retardation was measure for the transparent film with a dimension of 11 mm×8 mm in transmission mode by means of a birefringence measurement apparatus “Abrio” available from Tokyo Instruments, Inc.

Tables 1 and 2 show evaluation results obtained through the above measurement.

TABLE 1

| | | | | | | Comparative | Comparative |
|---|---|---|---|---|---|---|---|
| | | Example 1 | Example 2 | Example 3 | Example 4 | example 1 | example 2 |
| High refractive resin | VG3101 | 27 | 28 | 30 | 32 | 26 | 34 |
| | BADCy | 30 | 30 | 30 | 30 | 30 | 30 |
| Low refractive resin | EHPE3150 | 43 | 42 | 40 | 38 | 44 | 36 |
| Cure initiator | Zinc | 0.02 | 0.02 | 0.02 | 0.02 | 0.02 | 0.02 |
| | octanate | | | | | | |

| | | | | | | |
|---|---|---|---|---|---|---|
| Glass fiber | E-glass | E-glass | E-glass | E-glass | E-glass | E-glass |
| Glass cloth thickness (μm) | 25 | 25 | 25 | 25 | 25 | 25 |
| The number of superimposed | 2 | 2 | 2 | 2 | 2 | 2 |
| Glass cloth | | | | | | |
| Transparent film thickness (μm) | 70 | 70 | 70 | 70 | 70 | 70 |
| Transparency (Haze) | 2.0 | 2.0 | 2.1 | 2.3 | 1.9 | 2.8 |
| Glass transition temperature of | 240 | 240 | 240 | 240 | 240 | 240 |
| cured resin (° C.) | | | | | | |
| Refractive index of cured resin | 1.564 | 1.565 | 1.567 | 1.570 | 1.563 | 1.572 |
| Refractive index difference | 0.001 | 0.002 | 0.004 | 0.007 | 0 | 0.009 |
| between cured resin and glass | | | | | | |
| fiber n2 − n1 | | | | | | |
| Peak wavelength of light | 600 | 628 | 692 | 778 | 554 | 843 |
| transmission (nm) | | | | | | |
| Retardation (nm) | 1.4 | 1.3 | 1.2 | 1.2 | 1.5 | 1.6 |

TABLE 2

| | | | | | Comparative | Comparative |
|---|---|---|---|---|---|---|
| | | Example 5 | Example 6 | Example 7 | example 3 | example 4 |
| High refractive resin | VG3101 | 5 | 6.5 | 8 | 3 | 11 |
| Low refractive resin | EHPE3150 | 95 | 93.5 | 91 | 97 | 89 |
| Cure initiator | SI150L | 2 | 2 | 2 | 2 | 2 |

| | | | | | |
|---|---|---|---|---|---|
| Glass fiber | T-glass | T-glass | T-glass | T-glass | T-glass |
| Glass cloth thickness (μm) | 25 | 25 | 25 | 25 | 25 |
| The number of superimposed | 2 | 2 | 2 | 2 | 2 |
| Glass cloth | | | | | |
| Transparent film thickness (μm) | 70 | 70 | 70 | 70 | 70 |
| Transparency (Haze) | 0.8 | 0.9 | 1.0 | 2.3 | 1.3 |
| Glass transition temperature of | 210 | 210 | 210 | 210 | 210 |
| cured resin (° C.) | | | | | |
| Refractive index of cured resin | 1.529 | 1.532 | 1.535 | 1.528 | 1.537 |
| Refractive index difference | 0.001 | 0.004 | 0.007 | 0 | 0.009 |
| between cured resin and glass | | | | | |
| fiber n2 − n1 | | | | | |
| Peak wavelength of light | 620 | 687 | 795 | 520 | 862 |
| transmission (nm) | | | | | |
| Retardation (nm) | 0.7 | 0.6 | 0.5 | 1.2 | 0.8 |

As shown in Table 1, each of the transparent films in Examples 1 to 7 was found to exhibit a high glass transition temperature and high thermal resistance. Each of the transparent films in Examples 1 to 7 satisfies a relation of 0.001≦n2−n1≦0.007 between the glass fiber (refractive index: n₁) and the transparent resin (refractive index: n₂) and has a peak wavelength of 600 nm to 780 nm in terms of light transmission. Each transparent film proved to exhibit a minimized retardation as well as high transparency. Besides, each of the transparent films in Examples 1 to 7 was found to exhibit a reduced thermally-induced color variation Δb and a reduced thermally-induced coloring (not shown in Table 1).

In contrast, each of the transparent films in comparative examples 1 and 3 has a refractive index difference n₂−n₁ less than 0.001, between the glass fiber (refractive index: n₁) and the transparent resin (refractive index: n₂). Each of the transparent films in the Comparative examples was found to exhibit a significantly increased retardation, when controlled to have a peak wavelength below 600 nm in term of light transmission.

The transparent film in comparative example 2 has a refractive index difference n2−n1 more than 0.007, between the glass fiber (refractive index: n₁) and the transparent resin (refractive index: n₂). The transparent film in Comparative example 2 was found to exhibit a significantly increased retardation as that in Comparative example 1, when controlled to give a maximum light transmission at a wavelength above 780 nm. The transparent film in Comparative example 2 was found to exhibit a degraded transparency. The transparent film in comparative example 4 has a refractive index difference n2−n1 more than 0.007, between the glass fiber (refractive index: n₁) and the transparent resin (refractive index: n₂). The transparent film in Comparative example 4 was found to exhibit a retardation higher than those in Examples 5, 6 and 7, when controlled to give a maximum light transmission at a wavelength above 780 nm.

The above results demonstrate that each of the transparent films in Examples 1 to 7 has a refractive index difference n2−n1 within a specific range between the glass fiber (refractive index: n1) and the transparent resin (refractive index: n2) and exhibits a significantly reduced retardation as well as a significantly high transparency and high thermal resistance.

1. A transparent film comprising;
a transparent material made of a transparent resin;
a glass fiber substrate made of a glass fiber; said glass fiber substrate impregnated with said transparent material;
said transparent film satisfying a relation of 0.001≦n2−n1≦0.007 in which n1 and n2 are respectively refractive indexes of said glass fiber and said transparent material,
wherein said transparent film gives a maximum light transmission at a wavelength in a range of 600 nm to 780 nm.

2. The transparent film as set forth in claim 1, wherein said transparent material comprises a plurality of transparent resins having different refractive indexes.

3. The transparent film as set forth in claim 2, wherein said transparent material comprises a high refractive resin having a higher refractive index than said refractive index n1 of said glass fiber, and a low refractive resin having a lower refractive index than said refractive index n1 of said glass fiber.

4. The transparent film as set forth in claim 3, wherein said high refractive resin is formed of either one or both of
a cyanate ester resin; and
a multi-functional epoxy resin expressed by the following formula (I) ; 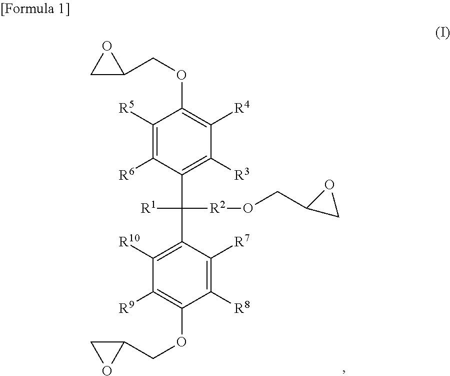
wherein R¹ is hydrogen atom or methyl group, R² is a divalent organic group, and each of R³ to R¹⁰ is one selected from a group consisting of a hydrogen atom, a substituent group, and a molecular chain containing epoxy group.

5. The transparent film as set forth in claim 3, wherein said low refractive resin is formed of a multi-functional epoxy resin expressed by the following formula (II); 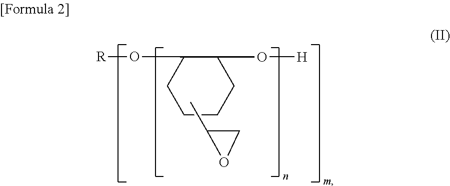
wherein m and n are positive integers, and R is an m-valent organic group.

6. The transparent film as set forth in claim 1, wherein said glass fiber is an E-glass fiber or a T-glass fiber.

7. The transparent film as set forth in claim 3, wherein said high refractive resin is formed of a cyanate ester resin and a multi-functional epoxy resin expressed by the following formula (I); 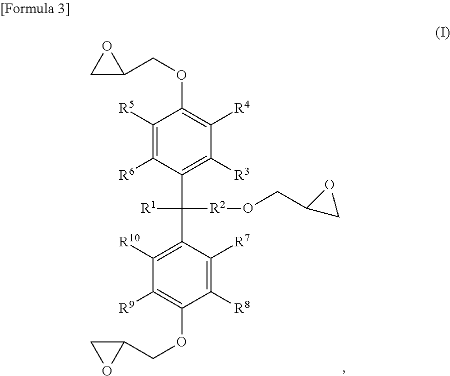
wherein R¹ is hydrogen atom or methyl group, R² is a divalent organic group, and each of R³ to R¹⁰ is one selected from a group consisting of a hydrogen atom, a substituent group, and a molecular chain containing epoxy group; and
wherein said low refractive resin is formed of a multi-functional epoxy resin expressed by the following formula (II), 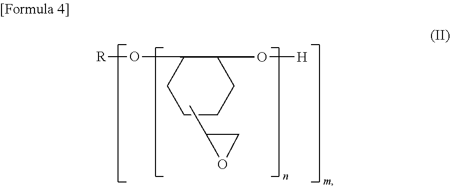
wherein in and n are positive integers, and R is an m-valent organic group.

8. The transparent film as set forth in claim 7, wherein said glass fiber is an E-glass fiber.

9. The transparent film as set forth in claim 8, comprising 38% to 43% by weight of said low refractive resin, with respect to a total content of said high refractive resin and said low refractive resin.

10. The transparent film as set forth in claim 3, wherein said high refractive resin is formed of a multi-functional epoxy resin expressed by the following formula (I); 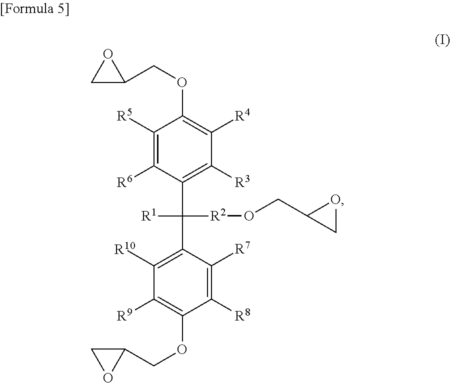
wherein R¹ is hydrogen atom or methyl group, R² is a divalent organic group, and each of R³ to R¹⁰ is one selected from a group consisting of a hydrogen atom, a substituent group, and a molecular chain containing epoxy group; and
wherein said low refractive resin is formed of a multi-functional epoxy resin expressed by the following formula (II), 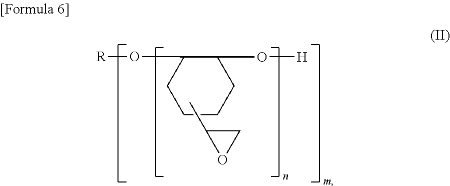
wherein m and n are positive integers, and R is an m-valent organic group.

11. The transparent film as set forth in claim 10, wherein said glass fiber is a T-glass fiber.

12. The transparent film as set forth in claim 11, comprising 90% to 96% by weight of said low refractive resin, with respect to a total content of said high refractive resin and said low refractive resin.

13. The transparent film as set forth claim 1, wherein a hard coat layer is provided on at least one of opposite surfaces thereof.

14. The transparent film as set forth in claim 1, wherein a gas barrier layer is provided on at least one of opposite surfaces thereof.

15. The transparent film as set forth in claim 4, wherein said low refractive resin is formed of a multi-functional epoxy resin expressed by the following formula (II); 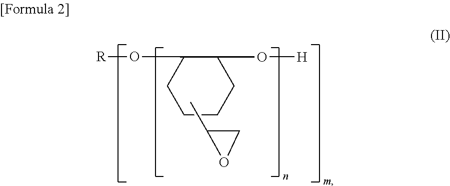
wherein m and n are positive integers, and R is an m-valent organic group.
